(19) United States
(12) Patent Application Publication
(10) Pub. No.: US 2025/0385373 A1
(43) Pub. Date: Dec. 18, 2025

(54) ELECTRICAL HOUSING FOR AN AIRCRAFT

(71) Applicant: SAFRAN ELECTRICAL & POWER, Blagnac Cedex (FR)

(72) Inventors: Kevin Kappler, Moissy-Cramayel (FR); Sébastien Thomassier, Moissy-Cramayel (FR)

(73) Assignee: SAFRAN ELECTRICAL & POWER, Blagnac Cedex (FR)

(21) Appl. No.: 18/723,863

(22) PCT Filed: Dec. 8, 2022
(86) PCT No.: PCT/FR2022/052288

§ 371 Date: Jan. 14, 2025

(30) Foreign Application Priority Data
Dec. 29, 2021 (FR) 2114603

(51) Int. Cl. H01M 50/262; B60L 50/64; B60L 58/24; B64D 33/08; H01M 10/613; H01M 10/625; H01M 10/6556; H01M 50/204; H01M 50/224; H01M 50/249; H01M 50/276

(52) U.S. Cl. CPC H01M 50/262; B60L 50/64; B60L 58/24; B64D 33/08; H01M 10/613; H01M 10/625; H01M 10/6556; H01M 50/204; H01M 50/224; H01M 50/249; H01M 50/276; B60L 2200/10; H01M 2220/20

(57) ABSTRACT

A housing for an electrical power storage battery includes a plate, onto which power elements of the battery are attached, and a bell cover covering the plate and means for mechanically attaching the bell cover onto the plate. The plate may include means for the electrical connection of the battery, means for the connection of communication means, and means for the thermal management of the electrical power elements.

### TECHNICAL FIELD

The present invention relates to the field of storing electrical power, in particular in the field of aeronautics. It also relates, in general, to the storage of electrical power, for uses in which the mass is a significant issue.

### PRIOR ART

Conventionally, in the field of aeronautics, the storage of electrical power is carried out via lithium-ion batteries with a low voltage, typically a voltage lower than 120V.

The term battery means a set of individual packs each comprising modules consisting of power elements and configured in combination in series and/or in parallel in order to reach the desired electrical voltage and electrical capacity.

Modern aircraft have increasing needs in terms of electrical power, which requires adjusting the batteries accordingly. In order to provide the electrical power required while minimising the weight of the electrical equipment, it is of interest to raise the voltage of the batteries, for example to 800V.

Conventionally, the batteries are disposed inside a housing composed of a tank covered by a cover. The tank allows to maintain the installed batteries in position and also ensures the structural rigidity of the tank. A sufficient rigidity can be obtained by imposing a minimum thickness onto the wall of the tank, but this is accompanied by a significant increase in the mass of the housing. In an improved design, the minimum thickness of the housing can be reduced using local reinforcements.

These solutions are accompanied by an increase in the mass of the housing, whether this is by increasing the minimum thickness of the tank or by providing reinforcements.

Moreover, the cover allows to close the tank in a sealed manner and integrates the connectors for electrical power and communication with systems for managing the electrical system for diagnostic, control and/or regulation purposes. The integration of the power and communication connectors can be accompanied by an increase in the risk of gas leaks in the case of thermal runaway, as well as a decrease in the resistance of the structure.

### DISCLOSURE OF THE INVENTION

Given the above, the goal of the invention is to overcome all or a part of the aforementioned disadvantages and to propose an electrical housing for a battery, without a notable increase in the mass.

Another goal of the invention is to propose such a housing, which avoids the risks of a gas leak and which furthermore meets the requirements of safety that are requisite in the field of aeronautics.

The object of the invention is therefore a housing for storing electrical power. The housing includes a plate onto which power elements of the battery and a bell cover covering the plate are attached and means for mechanically attaching the bell cover onto the plate. The plate comprises means for the electrical connection of the battery, means for the connection of communication means, and means for the thermal management of the power elements.

By integrating the power elements of the batteries, as well as the power, communications and thermal management connectors, onto a plate that supports all of the functional elements of the battery, the issues of rigidification of the support of the power elements are eliminated. Moreover, the level of integration of the battery, consisting of the ratio between the total mass of the equipment and the mass of the electrical power elements of the equipment, is improved. The improvement of this level of integration is accompanied by a respecting of the safety standards, in particular with regard to the risks of thermal runaway and the associated risks of gas leaks.

Advantageously, the bell cover is made of a material having a specific weight lower than that of the plate and/or resistant to heat.

The bell cover can comprise means for guiding gas emitted by the battery.

Preferably, the means for thermal management of the power elements comprise a cooling circuit.

In one embodiment, the plate is made of a metal material.

As for the bell cover, it can be made of a composite material having a ceramic matrix.

In one embodiment, the plate comprises a base provided with notches into which the bell cover is inserted.

Alternatively, the plate comprises a base comprising a peripheral edge defining a recess for receiving the bell cover and into which the means for mechanical attachment of the bell cover are inserted.

According to another feature of the housing according to the invention, a set of prestressed rigidification mounts extend between the plate and the bell cover.

The object of the invention is also a battery assembly for an aircraft, comprising a set of power elements and a housing as defined above, in which the power elements of the battery are mounted.

### BRIEF DESCRIPTION OF THE DRAWINGS

Other goals, features and advantages of the invention will appear upon reading the following description, given only as a non-limiting example, and made in reference to the appended drawings in which:

FIG. 1 is a perspective view of the main elements forming a housing according to the invention;

FIG. 2 is a longitudinal cross-sectional view of a housing according to the invention;

FIG. 3 illustrates an exploded view of a housing according to the invention;

FIG. 4 shows the housing of FIG. 3, in a closed position;

FIG. 5 illustrates an embodiment of a housing according to the invention; and

FIG. 6 illustrates an alternative embodiment of a housing according to the invention.

### DETAILED DISCLOSURE OF AT LEAST ONE EMBODIMENT

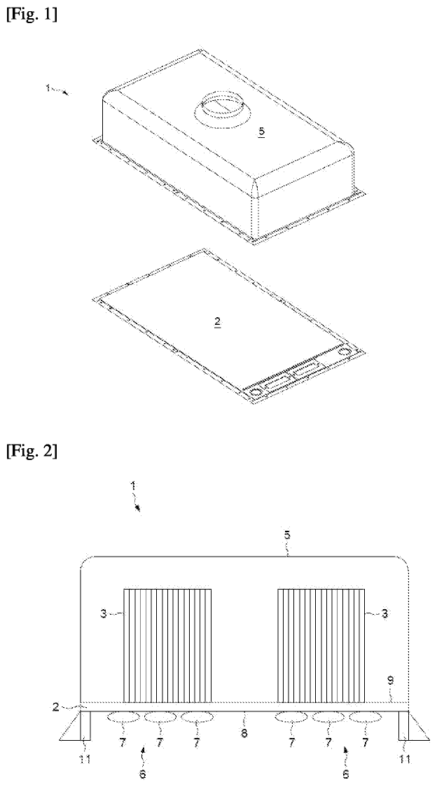

FIGS. 1 to 4 show an exemplary embodiment of a housing for a battery according to the invention, designated by the general numerical reference 1. This housing is intended to receive a battery.

In the embodiment described, this housing is intended to be on board an aircraft. It is noted, however, that the invention also applies, in general, to other fields in which issues of management of mass and of integration arise.

This housing is intended to ensure the mounting and the connectors of the power elements of the battery and to ensure the protection of the battery. It includes a plate 2 onto which the power elements 3 of the battery and a bell cover 5 are attached.

The plate 2 has the structural rigidity necessary to be able to receive by attachment the desired power elements 3.

The plate 2 can ensure a temperature management functionality and comprise for this purpose at least one cooling circuit 6 comprising hoses, such as 7, inside of which a coolant circulates. The plate 2 is advantageously made of a thermally conductive material, in this case a metal material.

The cooling circuit 6 is installed in a heat exchange relationship on the outer face 8 of the plate 2, that is to say on the face opposite to the inner face 9 that receives the batteries 3. It can also be integrated into the plate 2.

The plate 2 is cooled by the cooling circuit and consequently can cool the batteries 3 towards optimal operating temperatures.

For example, the cooling circuit comprises metal tubes, such as 10, welded to the plate 2.

Moreover, the plate 2 is equipped with several attachment elements 11 that allow its installation on board an aircraft. It is noted, however, that the plate can, alternatively, consist of a supporting structural element of the aircraft provided for the integration of the battery.

With regard to the bell cover 5, it covers all of the elements located inside the housing 1 and represents a physical barrier that separates and protects the inside of the housing 1 and its outside environment.

The bell cover is in particular intended to reduce the risk of gas leaks.

Moreover, in the case of an event of the thermal runaway type, the bell cover 5 ensures a function of protection of the outside environment of the housing 1 by limiting the impact of this event on the outside environment of the housing 1. It further ensures a function of guiding the gases emitted by the battery during its operation. The bell cover 5 comprises for this purpose a profiled opening 12 intended for the management of the gases and provided in order for the emitted gases to be guided in a desired direction. For example, the profiled opening 12 is maintained closed by a cover 13 likely to break in case of overpressure.

The bell cover 5 is made of a material simultaneously light, resistant and capable of ensuring the functionality of protection in the case of thermal runaway, for example of a composite material having a ceramic matrix or of a composite material comprising an inner thermal protection layer.

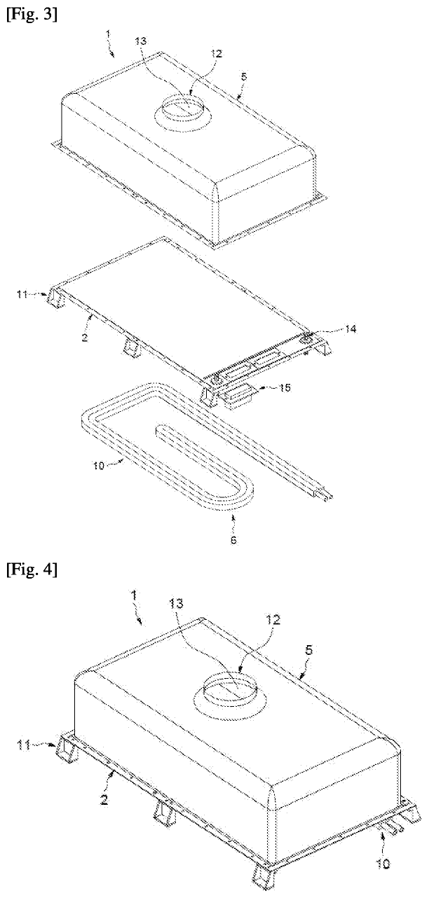

In reference to FIG. 3, the plate 2 comprises means for electrical connection of the battery, including a power connector 14 necessary to supply the systems of the aircraft with electrical current, as well as means for connecting communication means, including a connector for communication 15 with systems for managing the electrical system for purposes of diagnosis, control and/or regulation.

Finally, the housing is provided with means for mechanical attachment of the bell cover onto the plate, carried out for example in the form of screws, bolts or any other attachment means suitable for the intended use.

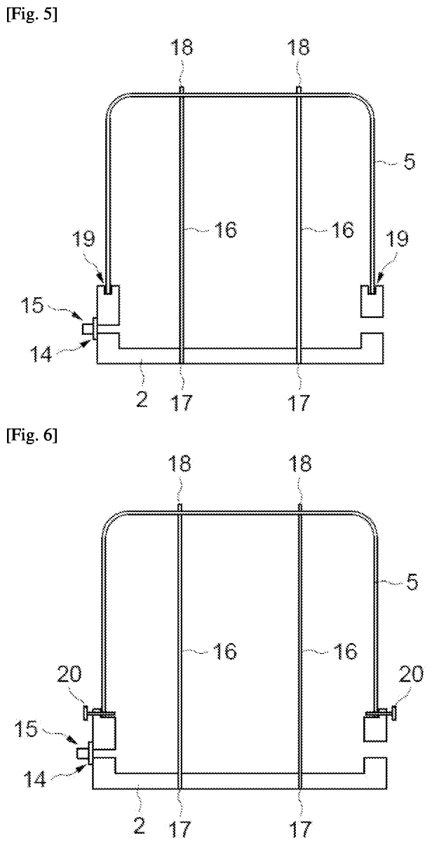

In reference to FIG. 5, in which elements identical to those described in reference to FIGS. 1 to 4 are designated by the same numerical another embodiment of a housing according to the invention will now be described.

In this embodiment, which is moreover identical to the embodiment of FIGS. 1 to 4, the plate 2 forms a base onto which the bell cover 5 is attached via a set of prestressed tie-rods 16 that furthermore ensure the rigidification of the housing.

Each tie-rod 16 comprises at its end a passive anchoring 17 attached in the plate 2 and, at the opposite end, an active anchoring 18 made in the bell cover 5. It should be noted that the attachment of the bell cover 5 to the plate 2 by prestressed tie-rods implements forces that balance themselves and which do not engender additional loads on the aircraft.

In this embodiment, the plate 2 includes a peripheral rim provided with notches 19 into which the bell cover 5 is inserted.

In an alternative, illustrated by FIG. 6 which is moreover identical to FIG. 5, the plate 2 also forms a base having an upright peripheral edge defining a recess for receiving the bell cover 5 of the plate 2. In this embodiment, the bell cover 5 is attached to the plate 2 via attachment elements 20 that are inserted into the bell cover 5 and the rim of the plate 2.

1. Housing for a battery for storing electrical power, wherein the housing includes a plate onto which power elements of the battery and a bell cover covering the plate are attached and means for mechanically attaching the bell cover onto the plate, the plate comprising means for the electrical connection of the battery, means for the connection of communication means, and means for the thermal management of the power elements, said plate forming a base provided with notches into which the bell cover is inserted.

2. Housing according to claim 1, wherein the bell cover is made of a material having a specific weight lower than that of the plate and/or resistant to heat.

3. Housing according to claim 1, wherein the bell cover comprises means for guiding gas emitted by the battery.

4. Housing according to claim 1, wherein the means for thermal management of the power elements comprises a cooling circuit.

5. Housing according to claim 1, wherein the plate is made of a metal material.

6. Housing according to claim 1, wherein the bell cover is made of a composite material having a ceramic matrix.

7. Housing according to claim 1, further comprising a set of prestressed rigidification mounts tie-rods extending between the plate and the bell cover.

8. Battery assembly for an aircraft, the battery assembly comprising a set of power elements and a housing according to claim 1 in which the power elements of the battery are mounted.
